(19) United States
(12) Patent Application Publication
(10) Pub. No.: US 2006/0231812 A1
(43) Pub. Date: Oct. 19, 2006

(54) Cable driven drive mechanism

(76) Inventors: James F. Ziech, Kalamazoo, MI (US); Michael Zebolsky, Marshall, MI (US); Paul Pollock, Mattawan, MI (US)

Correspondence Address: DYKEMA GOSSETT PLLC, 39577 WOODWARD AVENUE, SUITE 300, BLOOMFIELD HILLS, MI, 48304-5086, US

(21) Appl. No.: 11/097,486

(22) Filed: Apr. 1, 2005

(51) Int. Cl. B66D 1/26

(52) U.S. Cl. 254/278

(57) ABSTRACT

A cable driven drive mechanism is presented. A cable driven drive mechanism includes one or more drums rotatable about one or more parallel axes. The drive mechanism further includes one or more output drums rotatable about one or more parallel axes, the input axes extending perpendicular to the output axes. The cable driven drive mechanism still further includes a cable disposed about at least a portion of each of the input drums and the output drums, thereby coupling the input drums and output drums for rotation together.

### BACKGROUND OF THE INVENTION

1. Field of the Invention

This invention relates to a right angle drive mechanism, and more particularly, to a cable driven drive mechanism.

2. Disclosure of Related Art

Right angle drive mechanisms are employed in a variety of applications. One such application is a vehicle drive axle. A conventional drive mechanism for a drive axle typically includes, among other components, an input shaft, a pinion gear that is driven by the input shaft, and a ring gear that is in mesh with and driven by the pinion gear. These mechanisms are used as power transmission devices to transmit the rotation of the input shaft to axle half-shafts, for example, coupled to the ring gear in order to transmit the rotation, and thus torque, to the axle half-shafts, which are disposed at a right angle from the input shaft. Accordingly, in a vehicle application, for example, where a wheel is coupled to each axle half-shaft, the rotation of the input shaft is transmitted by the drive mechanism to cause the wheels to rotate.

The above-described drive mechanism has significant disadvantages, however. For instance, the combination of the pinion gear and the ring gear can have an adverse effect on the overall weight and cost of the system of which it is a part, and the alignment of the gears of conventional mechanisms requires high precision tolerances. Additionally, in operation, conventional drive mechanisms employing a pinion gear and a ring gear may produce undesirable noise due to gear tooth spacing errors and tooth deflection when a load is applied. The gears of conventional mechanisms may also require precise processing of the gear tooth geometry and require special alloy steel with premium heat treatment and surface preparation.

The inventors herein have recognized a need for a drive mechanism that will minimize and/or eliminate one or more of the above-identified deficiencies.

### SUMMARY OF THE INVENTION

The present invention is directed towards a cable driven drive mechanism.

In accordance with one aspect of the present invention, a general-purpose cable driven drive mechanism is provided. A cable driven drive mechanism in accordance with the present invention includes a first drum rotatable about a first axis contained in a first horizontal plane, the first drum being configured to be an input drum. The cable driven drive mechanism further includes a second drum rotatable about a second axis contained in a second horizontal plane wherein the second drum is configured to be an output drum and the second axis is perpendicular to the first axis. The cable driven drive mechanism still further includes a third drum rotatable about a third axis contained in a third horizontal plane wherein the third axis is parallel to one of the first and second axes. The cable driven drive mechanism yet still further includes a cable disposed about at least a portion of each of the first, second and third drums, thereby coupling the first, second and third drums for rotation together.

In accordance with another aspect of the present invention, a cable driven drive mechanism for a vehicle drive axle is provided. A cable driven drive mechanism for a vehicle drive axle includes a first input drum rotatable about a first axis contained in a first horizontal plane and an output drum rotatable about a second axis contained in a second horizontal plane. The second axis about which the output drum rotates extends perpendicular to the first axis about which the first input drum rotates. The cable driven drive mechanism further includes a cable disposed about at least a portion of each of the first input drum and the output drum, thereby coupling the first input drum and the output drum for rotation together. The cable driven drive mechanism still further includes a first axle half-shaft extending from one end of the output drum and rotatable with the output drum. The output drum transmitting torque to a first wheel coupled to the first axle-half shaft.

These and other features and objects of this invention will become apparent to one skilled in the art from the following detailed description and the accompanying drawings illustrating features of this invention by way of example.

### BRIEF DESCRIPTION OF THE DRAWINGS

FIG. 1 is a perspective view of one embodiment of a cable driven drive mechanism in accordance with the present invention.

FIG. 2 is a top plan view of the first and third drums of the exemplary embodiment of the drive mechanism depicted in FIG. 1.

FIG. 3 is side view of the second drum of the drive mechanism depicted in FIG. 1 along the lines 3-3 in FIG. 2.

FIG. 4 is a top plan view of the first and third drums in accordance with an alternate embodiment of the exemplary embodiment of the drive mechanism depicted in FIG. 1.

FIG. 5 is a perspective view of a second embodiment of a cable driven drive mechanism in accordance with the present invention.

FIG. 6 is a perspective view of an alternate embodiment of the drive mechanism depicted in FIG. 5.

FIG. 7 is a top plan view of the drive mechanism depicted in FIG. 6.

### DETAILED DESCRIPTION OF THE PREFERRED EMBODIMENT

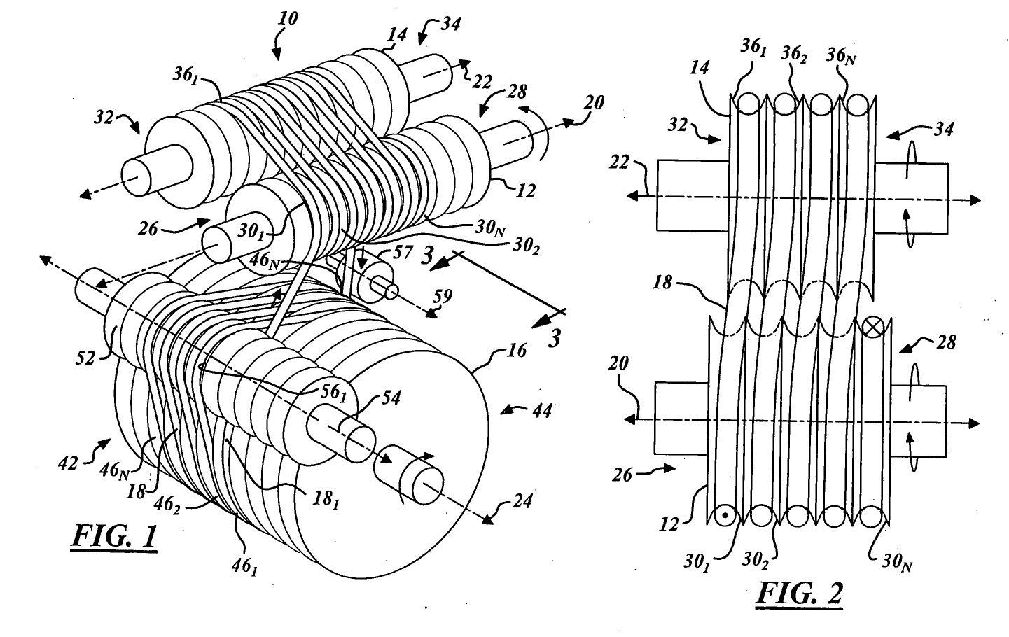

Referring now to the drawings wherein like reference numerals are used to identify identical components in the various views, FIGS. 1-4 illustrate one embodiment of a cable driven drive mechanism 10. Cable driven drive mechanism 10 includes a drum 12, a drum 14, a drum 16 and a cable 18.

With continued reference to FIGS. 1-3, drum 12 is configured to be an input drum that is driven by a power source, such as, for example, a motor, and is rotatable about an axis 20 that is contained in a horizontal plane. Drum 14 is rotatable about an axis 22 that is contained in a horizontal plane that may be offset from or co-planar with the horizontal plane in which axis 20 is contained. Drum 16 is configured to be an output drum that is driven by drum 12 and is rotatable about an axis 24 that is contained in a horizontal plane that maybe offset from or co-planar with the horizontal planes in which axes 20, 22 are contained. In the embodiment depicted in FIG. 1, first axis 20 and second axis 22 are parallel to each other and perpendicular to third axis 24. It should be noted, however, that in an alternate embodiment, axis 22 may be perpendicular to axis 20 and parallel to axis 24.

With respect to drum 12, drum 12 has first and second axial ends 26, 28 and is sized relative to the minimum bend radius of cable 18, therefore, drum 12 may have any diameter greater than the minimum bend radius of the particular cable used. One factor that is taken into consideration when selecting the size of the drum diameter to be used is the torque requirements needed for the application in connection with which drive mechanism 10 is being used.

In the exemplary embodiment illustrated in FIGS. 1 and 2, drum 12 includes a plurality of circumferential grooves 30 (i.e., 30₁, 30₂, 30₃ . . . 30_{N}) formed in the outer surface thereof. The plurality of grooves 30 extend, for example, from one axial end of drum 12 to the other. It should be noted, however, that the plurality of grooves 30 need not extend the entire axial length of drum 12, rather the plurality of grooves 30 can extend any axial extent in between axial ends 26, 28 of the drum, or not be included at all. Grooves 30 are sized and configured for the placement of cable 18 therein, and serve to prevent cable 18 from “walking off” of drum 12 as it rotates.

With respect to drum 14, in the illustrated embodiment shown in FIGS. 1 and 2, drum 14 has first and second axial ends 32, 34 and, as with drum 12, is sized relative to the minimum bend radius of cable 18, therefore, drum 14 may have any diameter greater than the minimum bend radius of the particular cable used. One factor that is taken into consideration when selecting the size of the drum diameter to be used is the torque requirements needed for the application in connection with which drive mechanism 10 is being used. Additionally, the diameters of drums 12, 14 are in the ratio of the required torque multiplication. In the illustrated embodiment that is provided for illustrative purposes only, and accordingly, is not meant to be limiting in nature, drum 12 and drum 14 are the same size.

In an exemplary embodiment, drum 14 includes a plurality of circumferential grooves 36 (i.e., 36₁, 36₂, 36₃ . . . 36_{N}) formed in the outer surface thereof. The plurality of grooves 36 extend, for example, from one axial end of drum 14 to the other. It should be noted, however, that the plurality of grooves 36 need not extend the entire axial length of drum 14, rather the plurality of grooves 36 can extend any axial extent in between axial ends 32, 34 of the drum, or not be included at all. Grooves 36 are sized and configured for the placement of cable 18 therein, and serve to prevent cable 18 from “walking off” drum 14 as it rotates. In a preferred embodiment, grooves 36 are offset from grooves 30 by one-half pitch. As will be discussed in greater detail below, in the illustrated embodiment this configuration allows for the movement of cable 18 from one of grooves 30 to an adjacent groove 36, and vice versa, such that cable 18 moves axially along drums 12, 14 as they rotate.

In the embodiment depicted in FIGS. 1 and 2, drums 12, 14 are oriented such that first axis 20 and second axis 22 are parallel and offset to each other. It should be noted however that this is simply one embodiment that is provided for illustrative purposes only. Other orientations of drum 12 and drum 14 exist that remain within the spirit and scope of the present invention. One such example is where first axis 20 and second axis 22 are aligned such that axes 20, 22 are disposed within a common vertical or horizontal plane.

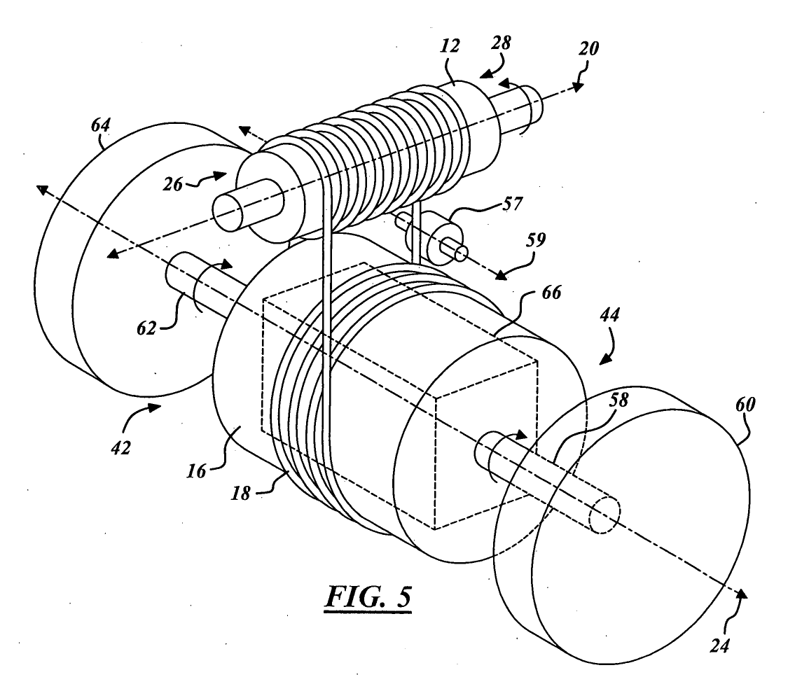

In an exemplary embodiment, drive mechanism 10 may further include a number of gears associated with the drums 12, 14. As shown in FIG. 4, gear 38 is coupled to drum 12 and gear 40 is coupled to drum 14. Gear 41 is disposed in between and in mesh with both gear 38 and gear 40. Gears 38, 40, 41 provide additional tractive effort of both drums 12, 14 as drum 12 rotates when driven by the power source.

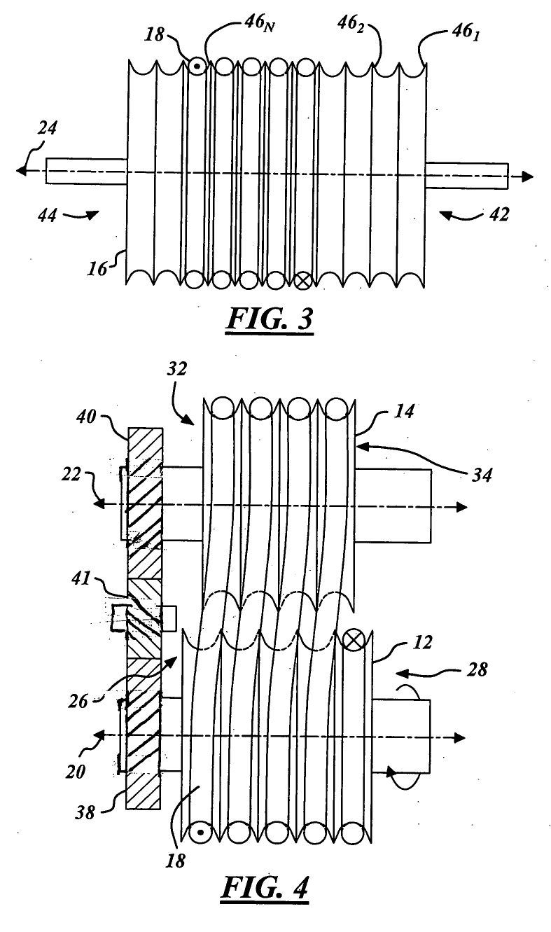

With respect to drum 16, and with reference to the exemplary embodiment depicted in FIGS. 1 and 3, drum 16 has first and second axial ends 42, 44 and is sized relative to the minimum bend radius of cable 18, and therefore, drum 16 may have any diameter greater than the minimum bend radius of the particular cable used. One factor that is taken into consideration when selecting the size of the drum diameter to be used is the torque requirements needed for the application in connection with which drive mechanism 10 is being used. Additionally, the diameters of drum 12, drum 14 and drum 16 are in the ratio of the required torque multiplication.

In an exemplary embodiment, drum 16 includes a plurality of circumferential grooves 46 (i.e., 46₁, 46₂, 46₃ . . . 46_{N}) formed in the outer surface thereof. The plurality of grooves 46 extend, for example, from one axial end of drum 16 to the other. It should be noted, however, that the plurality of grooves 46 need not extend the entire axial length of drum 16, rather the plurality of grooves 46 can extend any axial extent in between axial ends 42, 44 of the drum, or not be included at all. Grooves 46 are sized and configured for the placement of cable 18 therein, and serve to prevent cable 18 from “walking off” of drum 16 as it rotates. As discussed above, the orientation of drum 16 relative to drums 12, 14 in the illustrated embodiment is such that the respective axes of rotation of drums 12, 14 are perpendicular to the axis of rotation of drum 16, and thus, form a right angle relative to each other. In operation, drum 12, drum 14 and cable 18 are operative to transmit the rotation, and thus torque, applied to drum 12 to drum 16 so as to drive the rotation of drum 16 and any component coupled thereto, such as, for example, the axle half-shafts and wheels of a vehicle.

With reference to FIGS. 1 and 2, cable 18 is disposed or “wrapped” about at least a portion of drums 12, 14, 16, thereby coupling drum 12, drum 14 and drum 16 for rotation together. The traction of cable 18 on drums 12, 14, 16 is dependent upon the coefficient of friction. In an application where a high level of torque is needed, additional wraps of cable 18 around the respective drums will add torque capacity so that high torque capacity is possible in a low coefficient of friction environment, such as lubricated steel on steel. In the illustrated embodiment, cable 18 is wrapped approximately 180 degrees around drum 12 and then extends to drum 14 where it is wrapped approximately 180 degrees around drum 14. Cable 18 then extends back to drum 12 and again is wrapped approximately 180 degrees around drum 12. This winding pattern continues about drums 12, 14 a predetermined number of times depending on both the torque needed for the application in which the drive mechanism 10 is used and the diameter of drum 16. Accordingly, the greater the diameter of drum 16, the more wraps around drums 12, 14. In the embodiment depicted in FIGS. 1 and 2, cable 18 is disposed within grooves 30, 36 of drums 12, 14, respectively.

With continued reference to FIGS. 1 and 2, at or near the axial ends 26, 28 of drum 12, cable 18 extends to drum 16. Cable 18 extends from drum 12 to drum 16 and is then disposed about at least a portion of drum 16. In one embodiment, cable 18 is wrapped 360 degrees around drum 16 a predetermined number of times depending on both the torque to be transmitted by drum 16 and the diameter of drums 12, 14. Cable 18 then extends back to drum 12. In the embodiment depicted in FIGS. 1 and 3, cable 18 is disposed within grooves 46 of drum 16. As will discussed below, however, other embodiments exist wherein cable 18 is wrapped less than 360 degrees around drum 16 within grooves 46.

In operation, and with reference to the exemplary embodiment illustrated in FIGS. 1-3, as drum 12 rotates in a clockwise direction from the perspective of axial end 28, for example, cable 18 moves between the respective drums. For purposes of simplicity of explanation, the movement of cable 18 will be described with reference to a single point on cable 18 designated as “cable portion 18₁”. Accordingly, as drum 12 begins rotating in a clockwise direction, cable portion 18, disposed within one of grooves 46, 46₁ for example at or near axial end 44 of drum 16, is pulled out of groove 46₁ and is caused to be deposited into one of grooves 30, such as groove 30₁, for example, at or near axial end 26 of drum 12. As drum 12 continues to rotate, cable portion 18₁ travels, in the illustrated embodiment, 90 degrees around drum 12 in groove 30₁ and then moves out of groove 30₁ and is deposited into one of grooves 36, groove 36₁ for example, of drum 14 that is offset from and adjacent to groove 30₁. It should be noted that the degree of rotation around drum 12 just before cable 18 moves to drum 14 is dependent upon the orientation of drums 12, 14 relative to each other. For example, if drums 12, 14 are vertically aligned such that their respective axes of rotation are disposed in a common vertical plane rather than being offset, cable portion 18₁ would travel 180 degrees around drum 12 before moving to drum 14. Accordingly, this and other orientations of drums 12, 14 remain within the spirit and scope of the present invention.

As drum 12 continues to rotate, cable portion 18₁ travels 180 degrees around drum 14 in groove 36₁, for example. As cable 18 moves, drum 14 rotates in the same direction as drum 12. As drum 12 continues to rotate, cable portion 18₁ moves out of groove 36₁ and is placed back into one of grooves 30, groove 30₂, for example, of drum 12 that is offset from and adjacent to groove 36₁, and also adjacent to groove 30₁. As drum 12 continues to rotate, cable portion 18₁ progresses along drums 12, 14 in an axial direction, being lifted out of the respective grooves and deposited into adjacent grooves in adjacent positions due to the one-half pitch offset between grooves 30, 36 until cable portion 18₁ reaches a predetermined point on drum 12, which may be, but does not have to be, axial end 28 of first drum 12. Once cable portion 18₁ reaches the predetermined point, cable portion 18₁ is wrapped approximately 270 degrees, for example, around drum 12 and then moves out of groove 30_{N} and is placed into one of grooves 46, groove 46_{N} for example, at or near axial end 42 of drum 16. Again, as with the transition of cable 18 between drums 12, 14, it should be noted that the degree of rotation around drum 12 prior to cable 18 moving to drum 16 is dependent upon the orientation of drums 12, 14 relative to each other. For example, if drums 12, 14 are vertically aligned such that their respective axes of rotation are disposed in a common vertical plane rather than being offset, cable portion 18, would travel 180 degrees around drum 12. Accordingly, this and other orientations of drums 12, 14 remain within the spirit and scope of the present invention.

Once cable portion 18₁ moves onto drum 16, cable portion 18, travels 360 degrees around drum 16 for a predetermined number of turns until it reaches a predetermined point on drum 16, which may be, but does not have to be, axial end 44 of drum 16. Once cable portion 18₁ reaches the predetermined point, cable portion 18₁ moves out of groove 46, and is placed into groove 30₁ of drum 12, and then repeats the above sequence until drum 12 stops rotating. Accordingly, as drum 12 rotates in a clockwise direction, cable 18 moves causing drum 16 to also rotate in a clockwise direction, and therefore, the rotation of drum 12 is transmitted to drum 16.

In an exemplary embodiment, cable driven drive mechanism 10 further includes another drum 52 that is operative to apply and maintain tension on cable 18 as it travels throughout drive mechanism 10 and to move cable 18 within the grooves 46 of drum 16. In the embodiment illustrated in FIG. 1, drum 52 is rotatable about an axis 54 that is parallel to and offset from axis of rotation 24 of drum 16. As shown, cable 18 extends from drum 16, around a portion of drum 52 and then back to drum 16.

In an exemplary embodiment, drum 52 includes a plurality of circumferential grooves 56 (i.e., 56₁, 56₂, 56₃ . . . 56_{N}) formed in the outer surface thereof. The plurality of grooves 56 extend, for example, from one axial end of drum 52 to the other. It should be noted, however, that the plurality of grooves 56 need not extend the entire axial length of drum 52, rather the plurality of grooves 56 can extend any axial extent in between the axial ends of the drum or not be included at all. As with grooves 30, 36 and 46, grooves 56 are sized and configured for the placement of cable 18 therein, and serve to prevent cable 18 from “walking off” of drum 52 as it rotates. Additionally, in one exemplary embodiment, plurality of grooves 56 are offset from plurality of grooves 46 of drum 16 by one-half pitch in order to allow for the movement of cable 18 from one of grooves 46 in drum 16 to an adjacent groove 56 in drum 52, and vice versa, as the drums rotate. Accordingly, cable 18, for example, is lifted out of groove 46₂, is deposited into groove 56₁ that is offset from and adjacent to groove 46₂, travels around drum 52 and is then deposited into groove 46, that is offset from and adjacent to groove 561. Therefore, in an embodiment including drum 52, cable 18 does not make 360 degree revolutions around drum 16 within grooves 46. Rather, the combination of drum 52 and grooves 46, 56 lift and move cable 18 from groove to adjacent groove in drums 16, 52 to apply and maintain the tension on cable 18 and to move cable 18 along drum 16. It should be noted that while only the embodiment wherein drum 52 is offset from drum 16 is illustrated, the present invention is not so limited. Rather, in one alternate embodiment, for example, rotation axis 54 of drum 52 is parallel to and disposed within the same vertical plane as rotation axis 24 of drum 16. Accordingly, drum 52 may be located off to the side of or vertically aligned with drum 16. Additionally, drum 52 may be spring-loaded to provide a constant amount of tension on cable 18 as it stretches.

As shown in the exemplary embodiment illustrated in FIG. 1, cable driven drive mechanism 10 may further include an idler wheel 57. Idler wheel 57 is configured to apply and maintain tension on cable 18 as it travels throughout drive mechanism 10. In the illustrated embodiment, idler wheel 57 is rotatable about an axis 59 that is parallel to the axis of rotation 24 of drum 16, but is not so limited. Idler wheel 57 contacts cable 18 and applies tension thereto in order to take up stretch in cable 18, and therefore, maintain tension on cable 18. In one embodiment that includes both idler wheel 57 and fourth drum 52, fourth drum can have a fixed axis rather than being spring loaded. It should be noted that the embodiment shown in FIG. 1 with reference to idler wheel 57 is illustrative only and not meant to be limiting in nature. As such, other embodiments exist that remain within the spirit and scope of the present invention.

FIGS. 5-7 illustrate an alternate embodiment of cable driven drive mechanism 10. In this embodiment, cable driven drive mechanism 10 includes drum 12 (“input drum 12”), drum 16 (“output drum 16”), cable 18, a first axle half-shaft 58 extending from one axial end 42 of output drum 16, and a first wheel 60 coupled to first axle half-shaft 58. In an exemplary embodiment depicted in FIG. 5, drive mechanism 10 further includes a second axle half-shaft 62 extending from the other axial end 44 of output drum 16 and a second wheel 64 coupled to the second axle half-shaft 62.

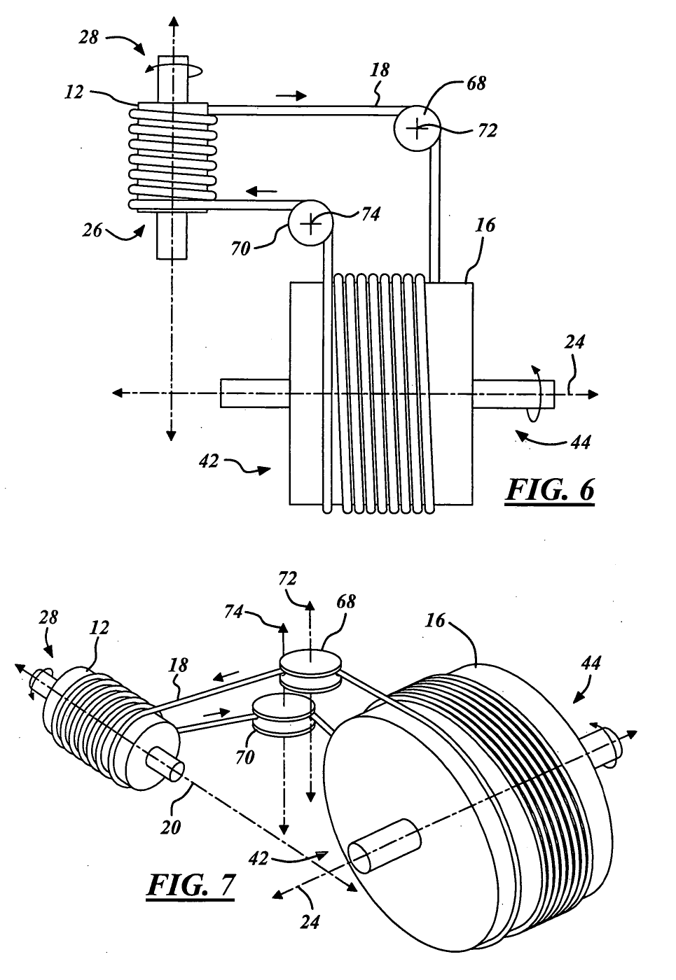

With continued reference to FIGS. 5-7, input drum 12 is configured to be driven by a power source, such as, for example, a motor, and is rotatable about first axis 20 that is contained in a first horizontal plane. Output drum 16 is rotatable about second axis 24 that is contained in a second horizontal plane and offset from first axis 20 such that the respective planes in which axes 20, 24 are disposed are both parallel to and offset from each other. As shown in FIG. 6, first and second axes 20, 24 are perpendicular to each other.

With respect to input drum 12, input drum 12 has first and second axial ends 26, 28 and is sized relative to the minimum bend radius of cable 18, therefore, input drum 12 may have any diameter greater than the minimum bend radius of the particular cable used. One factor that is taken into consideration when selecting the size of the drum diameter to be used is the torque requirements needed for the application in connection with which drive mechanism 10 is being used.

In one exemplary embodiment, input drum 12 includes a plurality of circumferential grooves 30 (i.e., 30₁, 30₂, 30₃ . . . 30_{N}) formed in the outer surface thereof. In one embodiment, the plurality of grooves 30 extend, for example, from one axial end of input drum 12 to the other. It should be noted, however, that plurality of grooves 30 need not extend the entire axial length of input drum 12, rather the plurality of grooves 30 can extend any axial extent in between axial ends 26, 28 of the drum or not be included at all. As discussed in greater detail above, grooves 30 are sized and configured for the placement of cable 18 therein, and serve to prevent cable 18 from “walking off” of input drum 12 as it rotates.

With respect to output drum 16, and with continued reference to FIGS. 5-7, output drum 16 has first and second axial ends 42, 44 and is also sized relative to the minimum bend radius of cable 18, and therefore, output drum 16 may have any diameter greater than the minimum bend radius of the particular cable used. One factor that is taken into consideration when selecting the size of the drum diameter to be used is the torque requirements needed for the application in connection with which drive mechanism 10 is being used; and the diameters of input drum 12 and output drum 16 are in the ratio of the required torque multiplication. Additionally, in an exemplary embodiment illustrated in FIG. 5, output drum 16 is configured to house a conventional wheel differential 66, and therefore, in this embodiment, output drum 16 must be large enough to accommodate wheel differential 66.

In an exemplary embodiment, output drum 16 includes a plurality of circumferential grooves 46 (i.e., 46₁, 46₂, 46₃ . . . 46_{N}) formed in the outer surface thereof. In one embodiment, the plurality of grooves 42 extend, for example, from one axial end of output drum 16 to the other. It should be noted, however, that plurality of grooves 46 need not extend the entire axial length of output drum 16, rather the plurality of grooves 46 may extend any axial extent in between axial ends 42, 44 of the drum or not be included at all. As discussed in greater detail above, grooves 46 are sized and configured for the placement of cable 18 therein, and serve to prevent cable 18 from “walking off” of output drum 16 as it rotates. As discussed above, the orientation of output drum 16 relative to input drum 12 is such that the respective axis of rotation 20 of input drum 12 is perpendicular to the axis of rotation 24 of output drum 16, and thus, forms a right angle relative to each other. In operation, input drum 12 is operative to transmit rotation imparted onto input drum 12 to output drum 16 and axle half-shafts 58, 62, so as to transmit torque to axle half-shafts 58, 62 and wheels 60, 64.

With continued reference to FIGS. 5-7, cable 18 is disposed about at least a portion of input drum 12 and output drum 16, thereby coupling input drum 12 and output drum 16 for rotation together. In the illustrated embodiment, cable 18 is wrapped around at least a portion of input drum 12 a predetermined number of times depending on both the torque needed to drive wheels 60, 64, for example, and the diameter of output drum 16. In an embodiment wherein input drum 12 includes a plurality of circumferential grooves 30, cable 18 is disposed within grooves 30.

As is illustrated in FIGS. 5-7, at or near the axial ends 26, 28 of input drum 12, cable 18 extends to output drum 16 and is then disposed about at least a portion of output drum 16. In the illustrated embodiment, cable 18 is wrapped 360 degrees around output drum 16 a predetermined number of times depending on the torque to be transmitted by output drum 16 and the diameter of input drum 12. Cable 18 then extends back to input drum 12. In the embodiment wherein output drum 16 includes a plurality of circumferential grooves 46, cable 18 is disposed within grooves 46.

In operation, and with reference to FIGS. 5-7, as input drum 12 rotates in a clockwise direction from the perspective of axial end 28, for example, cable 18 moves between the respective drums, thereby driving output drum 16, and therefore, axle half-shafts 58, 62 and wheels 60, 64. For purposes of simplicity of explanation, the movement of cable 18 will be described with reference to a single point on cable 18 designated as “cable portion 18₁”. Accordingly, as input drum 12 begins rotating in a clockwise direction, cable portion 18₁ is pulled off of output drum 16 and deposited onto input drum 12. As input drum 12 continues to rotate, cable portion 18₁ travels 360 degrees around input drum 12. As input drum 12 continues to rotate, cable portion 18₁ continues to travel around input drum 12 and progresses along input drum 12 until cable portion 18₁ reaches a predetermined point on input drum 12, which may be, but does not have to be, axial end 28 of first drum 12. Once cable portion 18₁ reaches the predetermined point, cable portion 18₁ is lifted off of input drum 12 and is deposited onto output drum 16.

Cable portion 18₁ then travels 360 degrees around output drum 16 for a predetermined number of turns until it reaches a predetermined point on output drum 16, which may be, but does not have to be, axial end 38 of output drum 16. Once cable portion 18₁ reaches the predetermined point, cable portion 18₁ is pulled off of output drum 16 and is deposited onto input drum 12, and then repeats the above sequence until input drum 12 stops rotating. In an embodiment wherein input drum 12 and output drum 16 include grooves 30, 46, the functionality of the drive mechanism is the same as that described above, with the exception that cable 18 is disposed and travels within and between grooves 30, 46. Accordingly, as input drum 12 rotates in a clockwise direction, cable 18 moves causing output drum 16 to rotate in a clockwise direction, thereby driving axle half-shafts 58, 62 and wheels 60, 64. Therefore, the rotation of input drum 12 is transmitted to output drum 16 which transmits torque to wheels 60, 64 coupled to axle half-shafts 58, 62.

In another embodiment, drive mechanism 10 further includes at least one pulley positioned between input drum 12 and output drum 16. With reference to FIGS. 6 and 7, pulleys 68, 70 are operative to increase tension on cable 18. Pulleys 68, 70 are positioned such that the portions of cable 18 between input drum 12 and output drum 16 are disposed about at least a portion of pulleys 68, 70, respectively. Pulleys 68, 70 may be rotatable about respective vertical axes 72, 74 and allow for the planes in which the axes of rotation 20, 24 for input drum 12 and output drum 16, respectively, are contained to be co-planar.

In an alternate embodiment, drive mechanism 10 further includes a input drum 14. In such an embodiment, the functionality of the embodiment described above applies here with equal force.

In a further alternate embodiment, cable driven drive mechanism 10 further includes idler wheel 57 that is operative to apply and maintain tension on cable 18 as it travels throughout drive mechanism 10. In the embodiment illustrated in FIGS. 5-7, idler wheel 57 is rotatable about an axis 59 that is parallel to axis of rotation 24 of output drum 16. As shown, idler wheel 57 contacts cable 18 and applies tension thereto in order to take up stretch in cable 18, and therefore maintain tension on cable 18.

While the invention has been particularly shown and described with reference to the preferred embodiments thereof, it is well understood by those skilled in the art that various changes and modifications can be made in the invention without departing from the spirit and scope of the invention.

We claim:

1. A cable driven drive mechanism, comprising:
a first drum rotatable about a first axis contained in a first horizontal plane, said first drum configured to be an input drum;
an second drum rotatable about a second axis contained in a second horizontal plane, said second axis extending perpendicular to said first axis and said second drum configured to be an output drum driven by said first drum;
a third drum rotatable about a third axis contained in a third horizontal plane, wherein said third axis is parallel to one of said first and second axes; and
a cable disposed about at least a portion of each of said first, second and third drums thereby coupling said first, second and third drums for rotation together.

2. A cable driven drive mechanism in accordance with claim 1 wherein said first, second and third drums each include a plurality of circumferential grooves formed in the outer surfaces thereof, said grooves configured for the placement of said cable therein.

3. A cable driven drive mechanism in accordance with claim 2 wherein said third axis is parallel to said first axis and said grooves of said third drum are offset from said grooves of said first drum by one-half pitch.

4. A cable driven drive mechanism in accordance with claim 2 wherein said third axis is parallel to said second axis and said grooves of said third drum are offset from said grooves of said second drum by one-half pitch.

5. A cable driven drive mechanism in accordance with claim 1 further comprising a fourth drum, said fourth drum rotatable about a fourth axis contained in a fourth horizontal plane wherein said fourth axis is parallel to the other of said first and second axes, said fourth drum configured such that said cable is disposed about at least a portion thereof.

6. A cable driven drive mechanism in accordance with claim 5 wherein said fourth drum includes a plurality of circumferential grooves formed in the outer surfaces thereof configured for the placement of said cable therein.

7. A cable driven drive mechanism in accordance with claim 1 wherein said third axis is parallel to said first axis, further comprising a gear set coupled to said first and third drums configured to provide additional tractive effort of said first and third drums.

8. A cable driven drive mechanism in accordance with claim 1 further comprising an idler wheel in contact with said cable and operative to apply and maintain tension on said cable.

9. A cable driven drive mechanism for a vehicle, comprising:
a first input drum rotatable about a first axis contained in a first horizontal plane;
an output drum rotatable about a second axis contained in a second horizontal plane, said second axis extending perpendicular to said first axis;
a cable disposed about at least a portion of each of said first input drum and said output drum coupling said first input drum and said output drum for rotation together; and
a first axle half-shaft extending from one end of said output drum and rotatable with said output drum, said output drum transmitting torque to a first wheel coupled to said first axle-half shaft.

10. A cable driven drive mechanism for a vehicle in accordance with claim 9 further comprising a second axle half-shaft extending from another end of said output drum and rotatable with said output drum, said output drum transmitting torque to a second wheel coupled to said second axle half-shaft.

11. A cable driven drive mechanism for a vehicle in accordance with claim 9 wherein said output drum houses a wheel differential.

12. A cable driven drive mechanism for a vehicle in accordance with claim 9 wherein said input and output drums each include a plurality of circumferential grooves formed in the surface thereof configured for the placement of said cable therein.

13. A cable driven drive mechanism for a vehicle in accordance with claim 9 further comprising a second input drum rotatable about a third axis contained in a third horizontal plane wherein said first and third axes are parallel to each other such that said second axis is perpendicular to said first and third axes.

14. A cable driven drive mechanism for a vehicle in accordance with claim 13 wherein said cable is disposed about at least a portion of said first and second input drums and said output drum coupling said first input drum, second input drum and output drum for rotation together.

15. A cable driven drive mechanism for a vehicle in accordance with claim 14 wherein said first and second input drums and said output drum each include a plurality of circumferential grooves formed in the outer surface thereof configured for the placement of said cable therein.

16. A cable driven drive mechanism for a vehicle in accordance with claim 15 wherein grooves in said second input drum are offset from said grooves in said first input drum by one-half pitch.

17. A cable driven drive mechanism for a vehicle in accordance with claim 9 further comprising an idler wheel in contact with said cable and operative to apply and maintain tension on said cable.

18. A cable driven drive mechanism for a vehicle in accordance with claim 9 wherein said first and second horizontal planes are parallel to and offset from each other.

19. A cable driven drive mechanism for a vehicle in accordance with claim 9 further comprising at least one pulley positioned between said input drum and said output drum operative to increase the tension on said cable.

20. A cable driven drive mechanism in accordance with claim 9 wherein said first and second horizontal planes are co-planar.
